(19) United States
(12) Patent Application Publication
(10) Pub. No.: US 2003/0160873 A1
(43) Pub. Date: Aug. 28, 2003

(54) Image capturing device that learns a wireless remote control

(76) Inventors: Kirk Steven Tecu, Greeley, CO (US); William Robert Haas, Fort Collins, CO (US); David Boll, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/083,028

(22) Filed: Feb. 26, 2002

(51) Int. Cl. H04N 5/232

(52) U.S. Cl. 348/211.2

(57) ABSTRACT

An image capturing device includes a wireless receiver, at least one input device, a memory, and a processor. The memory includes a learned commands table that stores one or more received remote control commands and associated user input commands. The processor receives a remote control command from the wireless receiver, receives a user input from the at least one input device, recalls a user input command corresponding to the user input, associates the remote control command with the user input command, and stores the remote control command and the user input command in the learned command table.

### FIELD OF THE INVENTION

The present invention relates generally to an image capturing device, and more particularly to an image capturing device that learns a remote control.

### BACKGROUND OF THE INVENTION

Image capturing devices, such as cameras, are typically used to capture scenes, persons, settings, occasions or events, etc. A digital image capturing device captures and stores images electronically and therefore requires no film. A digital image capturing device can capture images of different resolution, including high resolution images. The images can be downloaded, printed, resized, transmitted, etc. The user may instantly review a captured image to see if it is satisfactory. If the image is not satisfactory, the image may be erased and a new image may be captured. For all these reasons, digital image capturing devices are becoming increasingly popular.

Digital images captured by a digital image capturing device may be stored in a fixed or removable memory. A typical image size is up to about 700 kilobytes (Kb), depending upon the number of pixels in the image sensor (fixed), the image resolution (generally user-settable), and the image compression being used (chosen by the designer).

The amount of memory included in digital cameras continues to grow as memory becomes increasingly cheaper and larger in capacity. Therefore, the camera as an image capturing device may become less important than the camera as an image storage and image reviewing device.

Therefore, there remains a need in the art for improvement to image capturing devices.

### SUMMARY OF THE INVENTION

An image capturing device comprises a wireless receiver, at least one input device, a memory, and a processor. The memory includes a learned commands table that stores one or more received remote control commands and associated user input commands. The processor receives a remote control command from the wireless receiver, receives a user input from the at least one input device, recalls a user input command corresponding to the user input, associates the remote control command with the user input command, and stores the remote control command and the user input command in the learned command tab le.

### BRIEF DESCRIPTION OF THE DRAWINGS

FIG. 1 is a schematic of a digital image capturing device according to one embodiment of the invention;

FIG. 2 is a flowchart of a remote control method according to another embodiment of the invention;

FIG. 3 is a flowchart of a remote control method according to yet another embodiment of the invention;

FIG. 4 is a flowchart of a remote control learning method according to yet another embodiment of the invention; and

FIG. 5 is a flowchart of a slideshow control method according to another embodiment of the invention.

### DETAILED DESCRIPTION

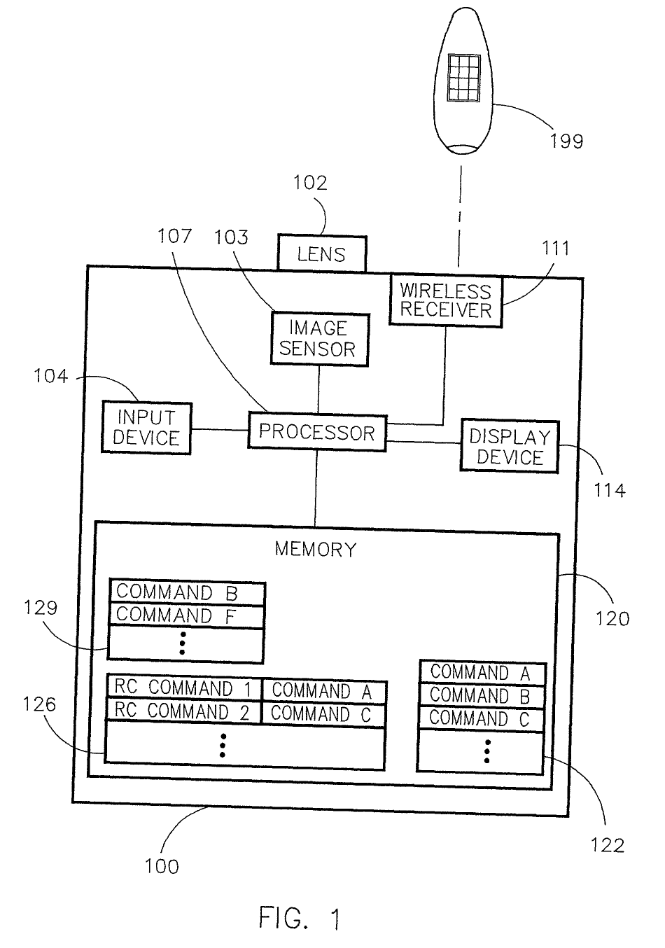

FIG. 1 is a schematic of a digital image capturing device 100 according to one embodiment of the invention. The image capturing device 100 may include a lens apparatus 102, an image sensor 103, at least one input device 104, a processor 107, a wireless receiver 111, a display device 114, and a memory 120.

The image sensor 103 may be any type of electronic image sensor capable of capturing images, such as a charge coupled device (CCD) sensor or a complementary metal oxide semiconductor (CMOS) sensor, for example.

The wireless receiver 111 may be any type of wireless receiver, including an infrared (IR) receiver or a radio frequency (RF) receiver. The wireless receiver 111 may receive a wireless communication from a wireless remote control 199.

The remote control 199 may be a custom remote control, designed for a specific electronics device. Therefore, the remote control 199 may be designed for a camera, a TV, VCR, stereo, etc. Alternatively, the remote control 199 may be a universal remote control that can be programmed to output various commands for a plurality of electronic devices. Because most households include televisions, VCRs, etc., it is likely that the owner of the image capturing device 100 owns at least one remote control 199.

An advantage of the image capturing device 100 according to the invention is that it may be used with any manner of remote control 199, and does not interact only with a specific remote control, as will be discussed below.

The input device 104 may be any manner of input device, such as keys, buttons, switches, etc. The input device 104 accepts user inputs and provides corresponding electrical signals to the processor 107.

The display device 114 may be any manner of camera display, such as a camera-back LCD, but may possibly even be a viewfinder display or a status display LCD. The display device 114 may display information to the user, including displaying menus, displaying a selection of operations, and even displaying captured images.

It should be understood that the input device 104 and display device 114 may be an integrated user interface, such as an LCD screen with programmable soft keys or a touch screen, for example.

The processor 107 may be any type of general purpose processor. The processor 107 executes a control routine contained in the memory 120. In addition, the processor 107 receives inputs and conducts image capturing operations.

The memory 120 may be any type of digital memory. The memory 120 may include, among other things, a user input commands table 122, a learned command table 126, and a learnable commands table 129. In addition, the memory 120 may store captured images and software or firmware to be executed by the processor 107.

The user input commands table 122 stores multiple command entries. The user input commands table 122 translates a user input (i.e., a press of an input switch or button) into one or more user input commands. The one or more user input commands are used by the processor 107 in operation of the image capturing device 100. For example, when the shutter button is pressed, the shutter button press may be translated into one or more commands, such as a set focus distance command, a set flash on command, a lens apparatus movement command, and a shutter actuation command.

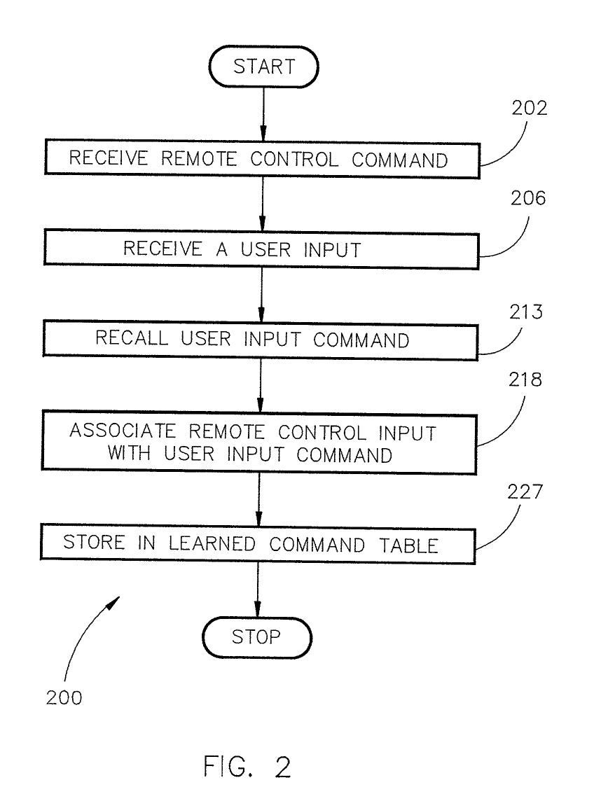

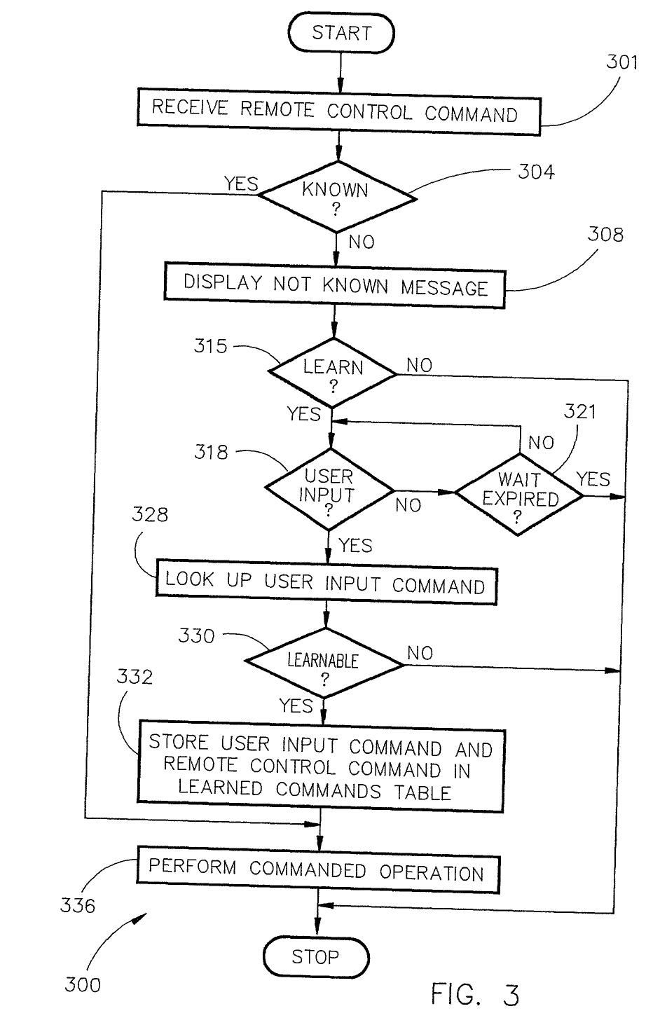

The learned command table 126 is used to learn commands received from the remote control 199 via the wireless receiver 111. In a learning mode, the image capturing device 100 receives a remote control command, accepts a user input from an input device 104, and associates the remote control command with the user input (see FIGS. 2 and 3 below and accompanying discussion). A remote control command and an associated (i.e., a learned) user input command are stored in the learned command table 126. Therefore, the remote control 199 may control functions of the image capturing device 100. In addition, the user may delete entries from the learned command table 126 in order to reprogram the image capturing device 100 or to eliminate an operation controlled by the remote control 199.

For example, the remote control 199 may be used to control a slideshow mode for reviewing captured images. Consequently, the learned command table 126 may include slideshow user input commands such as a previous image command, a next image command, a delete command, a zoom command, a rotate command, etc.

The learnable commands table 129 is an optional table that lists the user input commands that can be associated and learned by the image capturing device 100. This table may limit the learnable operations. Therefore, the operations that are controllable by the remote control 199 may be a subset of the operations that are controllable by buttons, switches, etc., on the image capturing device 100.

FIG. 2 is a flowchart 200 of a remote control method according to another embodiment of the invention. In step 202, a remote control command is received from the wireless remote control 199. The remote control command may comprise an IR signal or an RF signal.

In step 206, a user input is received, such as a button press or switch closure. In addition, this step may include checking the learnable commands table 129 to see if the user input is learnable.

In step 213, a user input command corresponding to the user input is recalled, such as from the user input commands table 122. The user input commands table 122 correlates a user input from a button or switch matrix of the image capturing device 100 to a user input command.

In step 218, the remote control command is associated with the recalled user input command, i.e., it is learned. This may be done, for example, by receiving the user input within a learning time period after the remote control command is received. Alternatively, it may be done by initiating a learning mode before receiving the remote control command, or by pressing a learn button, etc., after the remote control command is received.

In step 227, the remote control command and the associated user input command are stored as an entry in the learned command table 126.

FIG. 3 is a flowchart 300 of a remote control method according to yet another embodiment of the invention. In step 301, a remote control command is received.

In step 304, it is determined whether the remote control command is known, i.e., the image capturing device 100 may check the learned commands table 126. If the received remote control command is not in the learned commands table 126, the method proceeds to step 308; otherwise it branches to step 336.

In step 308, a not-known status is displayed to the user, such as through a camera-back display of the image capturing device 100. The image capturing device 100 therefore may indicate that the command received from the remote control 199 is not known. In addition, the image capturing device 100 may generate an audible tone or any other manner of fault indication. The display may prompt the user to enter another input that specifies whether the image capturing device 100 is to learn the unknown command from the remote control 199.

In step 315, a user learn input is accepted. If the user desires that the image capturing device 100 learn the received remote control command, the method proceeds to step 318; otherwise it exits.

In step 318, the image capturing device 100 enters a learning mode and waits for a user input.

In step 321, the image capturing device 100 waits a predetermined wait period. If the predetermined wait period expires, the method exits; otherwise if a user input is received during the predetermined wait period, the method proceeds to step 328.

In step 328, the image capturing device 100 looks up the corresponding user input command corresponding to the user input. This may include looking up the user input command from the user input commands table 122.

In step 330, the image capturing device 100 may check the learnable commands table 129 to see if the image capturing device 100 is allowed to learn the received remote control command.

In step 332, the received remote control command and the user input command are stored in the learnable commands table 126.

In step 336, the image capturing device 100 may optionally perform the commanded operation. Alternatively, the image capturing device 100 may not perform the commanded operation when in the learning mode and the user may have to generate another remote control command before the operation is actually performed.

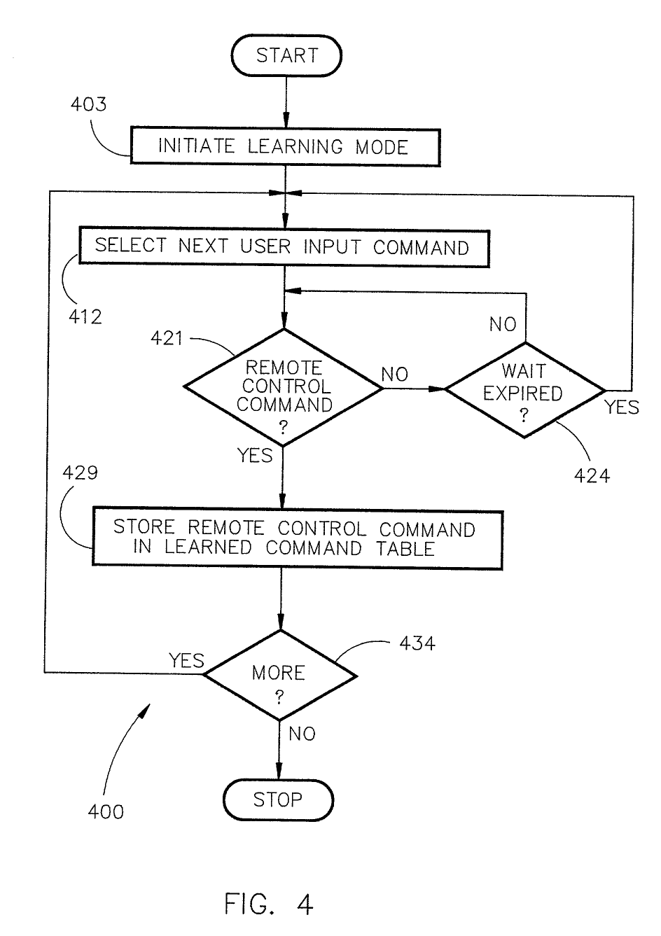

FIG. 4 is a flowchart 400 of a remote control learning method according to yet another embodiment of the invention. In this embodiment, the image capturing device 100 sequences through a pre-defined set of user input commands, incrementing the user input command each time a remote control command is received. In step 403, the user initiates the remote control learning mode by pressing a specific learning button or by navigating to and selecting a specific learning menu item.

In step 412, the image capturing device 100 selects a next user input command to be learned. This may comprise selecting a next user input command from the user input commands table 122, or may comprise selecting a next user input command from the learnable commands table 129.

In step 421, the method checks for a remote control command from the remote control 199. If the image capturing device 100 does not receive a remote control command, the method branches to step 424; otherwise it proceeds to step 429.

In step 424, the image capturing device 100 waits for a remote control command for a predetermined wait period. If a remote control command is not received within the predetermined wait period, the image capturing device 100 branches back to step 412 and sequences to the next user input command.

In step 429, the received remote control command is stored in the learned command table 126. The received remote control command is stored along with the associated user input command.

In step 434, the image capturing device 100 determines if there are any more user input commands to be processed. If there are, the image capturing device 100 branches back to step 412, where the next user input command is obtained. This continues until the sequence of user input commands or learnable user input commands has been processed. Otherwise the method exits. In this manner, the image capturing device 100 may iteratively process the user input commands, and the user may choose to associate a remote control command with a user input command.

In one example, the image capturing device 100 is pre-programmed to accept remote control commands for next image, previous image, delete, zoom, and rotate operations, for example. In order to initiate the learning process, the user navigates to and selects a “learn a remote control” menu item, for example. The image capturing device 100 then displays a “press ‘next image’ button” message. In response, the user presses a channel up button on the remote control 199. The channel up button function of the remote control 199 is stored in the learned command table 126 as a next image user input command. The image capturing device 100 next displays “press ‘previous image’ button.” In response, the user presses a channel down button on the remote control 199. The channel down button function of the remote control 199 is stored in the learned command table 126 as a previous image user input command. The image capturing device 100 next displays a “press ‘delete’ button” message. If the user does not wish to program this button, the user merely waits 10 seconds, for example, until the image capturing device 100 goes to the next step. No new entry is stored in the learned command table 126. The image capturing device 100 next displays a “press ‘zoom’ button” message. In response, the user presses a fast forward button on the remote control 199. The fast forward button function of the remote control 199 is stored in the learned command table 126 as a zoom user input command. The image capturing device 100 next displays a “press ‘rotate’ button” message. In response, the user presses a rewind button on the remote control 199. The rewind button function of the remote control 199 is stored in the learned command table 126 as a rotate user input command. In conclusion, the image capturing device displays a programming successful message and returns to the menu mode. The learning of the remote control 199 is therefore complete.

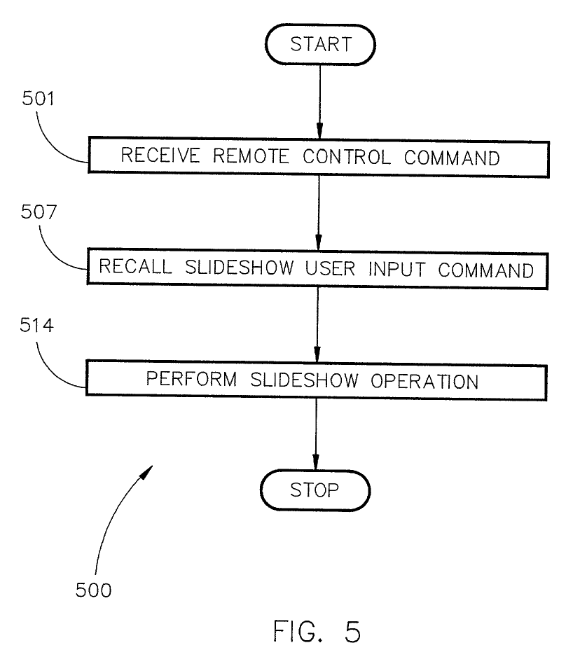

FIG. 5 is a flowchart 500 of a slideshow control method according to another embodiment of the invention. In step 501, a slideshow remote control command is received. The slideshow remote control command may be a learned slideshow remote control command as discussed above. Alternatively, the slideshow remote control command may be a slideshow command from a custom remote control designed for the particular image capturing device.

In step 507, a slideshow user input command corresponding to the received slideshow remote control command is recalled. This may include recalling the received remote control command from the learnable commands table 126 in order to obtain a corresponding slideshow user input command.

In step 514, a corresponding slideshow operation is performed.

The remote control learning capability may be employed by any digital still camera. In addition, the remote control learning capability may be employed by video cameras, including video cameras that capture still digital images.

The image capturing device according to the invention differs from the prior art in that the image capturing device learns commands from the remote control. The remote control does not have to be known by the image capturing device. The image capturing device according to the invention does not have to be designed to interact with specific remote control commands.

The remote control learning capability according to the invention provides several benefits. The image capturing device can be programmed to interact with multiple remote controls. The image capturing device may be reprogrammed at any time, such as when the user obtains a new remote control. For example, the user may need to reprogram the image capturing device when the user replaces a television and associated remote control. The image capturing device may interact with any type or number of remote controls. There is no need for another remote control specifically designed for a particular image capturing device, as most persons already have more than one remote control. The user may program the image capturing device to interact with one or more remote controls in order to implement desired actions. Moreover, the user may choose which keys of the remote control correspond to which actions of the image capturing device.

We claim:

1. An image capturing device, comprising:
a wireless receiver capable of receiving remote control commands from a wireless remote control device;
at least one input device capable of accepting user inputs;
a memory including a learned commands table that stores one or more received remote control commands and associated user input commands; and
a processor communicating with said wireless receiver, said at least one input device, and said memory, with said processor receiving a remote control command from said wireless receiver, receiving a user input from said at least one input device, recalling a user input command corresponding to said user input, associating said remote control command with said user input command, and storing said remote control command and said user input in said learned command table.

2. The device of claim 1, wherein said wireless receiver comprises an infrared (IR) receiver.

3. The device of claim 1, wherein said wireless receiver comprises a radio frequency (RF) receiver.

4. The device of claim 1, further comprising a learnable commands table that specifies one or more user input commands that are capable of being associated with said remote control commands.

5. The device of claim 1, wherein said learned commands table stores one or more slideshow user input commands that are associated with said remote control commands.

6. The device of claim 1, further comprising a user input commands table for recalling one or more particular user input commands corresponding to a particular user input.

7. A remote control method for an image capturing device, comprising the steps of:
receiving a remote control command in said image capturing device from at least one wireless remote control;
receiving a user input in said image capturing device;
recalling a user input command corresponding to said user input;
associating said remote control command with said user input command; and
storing said remote control command and said user input command in an entry of a learned command table;
wherein said image capturing device learns said remote control command from said at least one wireless remote control.

8. The method of claim 7, further comprising a preliminary step of placing said image capturing device in a learning mode.

9. The method of claim 7, wherein the step of receiving a remote control command is performed only if said image capturing device is in a learning mode.

10. The method of claim 7, wherein the step of receiving a user input is performed only if said image capturing device is in a learning mode.

11. The method of claim 7, wherein the associating step is performed only if said user input command is in a learnable commands table.

12. The method of claim 7, further comprising the steps of:
recalling a slideshow user input command corresponding to said remote control command if said remote control command is a slideshow command; and
performing a slideshow operation in said image capturing device corresponding to said slideshow user input command.

13. A remote control method for an image capturing device, comprising the steps of:
receiving a remote control command in said image capturing device from at least one wireless remote control;
displaying a not known status if said remote control command is not stored in a learned commands table in said image capturing device;
determining if said image capturing device is in a learning mode;
receiving a user input in said image capturing device if said image capturing device is in said learning mode;
recalling a user input command corresponding to said user input if said image capturing device is in said learning mode;
associating said remote control command with said user input command if said image capturing device is in said learning mode; and
storing said remote control command and said user input command in an entry of a learned command table if said image capturing device is in said learning mode;
wherein said image capturing device learns said remote control command from said at least one wireless remote control.

14. The method of claim 13, further comprising a preliminary step of placing said image capturing device in a learning mode.

15. The method of claim 13, wherein the step of receiving a remote control command is performed only if said image capturing device is in a learning mode.

16. The method of claim 13, wherein the step of receiving a user input is performed only if said image capturing device is in a learning mode.

17. The method of claim 13, wherein the associating step is performed only if said user input command is in a learnable commands table.

18. The method of claim 13, further comprising the steps of:
recalling a slideshow user input command corresponding to said remote control command if said remote control command is a slideshow command; and
performing a slideshow operation in said image capturing device corresponding to said slideshow user input command.

19. A remote control method for an image capturing device, comprising the steps of:
initiating a learning mode in said image capturing device;
selecting a user input command of said image capturing device;
receiving a remote control command from a wireless remote control; and
storing said remote control command and said user input command in an entry of a learned command table.

20. The method of claim 19, wherein the initiating, selecting, receiving, and storing steps are iteratively performed for a plurality of user input commands of said image capturing device.

21. The method of claim 19, wherein the initiating, selecting, receiving, and storing steps are iteratively performed for a learnable subset of user input commands of said image capturing device.

22. The method of claim 19, wherein said image capturing device waits a predetermined wait period to receive said remote control command.

23. The method of claim 19, wherein said image capturing device waits a predetermined wait period to receive said remote control command and selects a next user input command if said predetermined wait period expires.

24. The method of claim 19, wherein the associating step is performed only if said user input command is in a learnable commands table.

25. A remote control method for an image capturing device, comprising the steps of:
receiving a slideshow remote control command in said image capturing device from a wireless remote control;
recalling a slideshow user input command corresponding to said slideshow remote control command; and
performing a slideshow operation corresponding to said slideshow user input command.

26. The method of claim 25, further comprising the step of learning said slideshow remote control command.
